(19) United States
(12) Patent Application Publication
(10) Pub. No.: US 2019/0236242 A1
(43) Pub. Date: Aug. 1, 2019

(54) MECHANICAL AND CONTROL INTEGRATION DESIGN METHOD BASED ON PREDICTION MODEL AND QUICK DISTURBANCE ELIMINATION

(71) Applicant: GUANGDONG UNIVERSITY OF TECHNOLOGY, Guangzhou (CN)

(72) Inventors: ZHIJUN YANG, GUANGZHOU (CN); YOUDUN BAI, GUANGZHOU (CN); XIN CHEN, GUANGZHOU (CN); YAOBIN HE, GUANGZHOU (CN)

(73) Assignee: GUANGDONG UNIVERSITY OF TECHNOLOGY

(21) Appl. No.: 15/990,674

(22) Filed: May 27, 2018

(30) Foreign Application Priority Data
Jan. 30, 2018 (CN) 201810087374.X

(51) Int. Cl. G06F 17/50

(52) U.S. Cl. CPC G06F 17/5086

(57) ABSTRACT

The present invention provides a mechanical and control integration design method, comprising: first building an initial model of a controlled object, and regarding the estimation of an undetermined part as a disturbance; performing parametric design to the determined part of the controlled object model to obtain a parameterized model; further truncating and simplifying the controlled object model according to dynamic response characteristics of the object model and the control target requirements to obtain an approximate model as a prediction model; measuring a system state, building a control performance judgment criterion, and calculating the difference with the calculation result of the prediction model to obtain the total disturbance of the system; designing a total disturbance eliminating link according to the order of the prediction model, and constructing and completing an auto-disturbance rejection controller.

### CROSS-REFERENCE TO RELATED APPLICATIONS

This application claims priority to Chinese Patent Application No. 201810087374.X with a filing date of Jan. 30, 2018. The content of the aforementioned applications, including any intervening amendments thereto, are incorporated herein by reference.

### TECHNICAL FIELD

The present invention relates to the technical field of electromechanical integration, and more specifically to a mechanical and control integration design method.

### BACKGROUND

In the field of electromechanical integration, after a mechanism for realizing functions is comprehensively determined, several links concerning a structural design, a control system design, and a motion plan are usually needed to achieve the final requirements of an electromechanical system. These links are often completed by different engineers and lack a unified method. In addition, every design field is limited by constraints in other fields and can only obtain locally optimal solutions. With the improvement of the requirement of the mechanical and electrical products on comprehensive performance such as precision, speed, etc., the traditional method has almost come to an end. Whether there is a unified method to realize the globally optimal solution of an electromechanical integration device has become a new challenge for an electromechanical integration design. The Auto-Disturbance Rejection Control (ADRC) idea gets the total disturbance of the system based on the deviation between the model prediction and measurement, and the total disturbance is eliminated by an error elimination mechanism. A new steady state is achieved after repeated iterations. This provides an entirely new perspective for the design of the system. The existing researches on the ADRC mainly focus on the construction of an extended observation model and the adjustment of control parameters. In the ADRC design, the prediction model of an extended observer influences the performance of the system. When there is no prediction model, the bandwidth of the observer needs to be greater than 10 times of the disturbance bandwidth. When there is a prediction model, the bandwidth of the observer could be reduced to ⅓, which is about 3 times of the disturbance bandwidth. The increase in the bandwidth of the observer means the increase in the control cost. If the disturbance bandwidth could be reduced through the design of the mechanical system, the bandwidth of the observer could be reduced so as to reduce the cost of the control system.

As shown in FIG. 1, with the model prediction and disturbance elimination of the controlled object as the core, in combination with the ADRC idea and the quick convergence design criterion of an iterative method in mathematics, the traditional segmented design flow of the electromechanical system is changed into a quick convergence iterative algorithm design similar to a model based on a prediction model.

The patent with application number of CN201310699940.X discloses a mechanical, control and motor integration design method, wherein a mechanical system is a three-dimensional model designed by Pro/E or Solidworks and then imported into ADAMS, and becomes a visual multi-body dynamics model after drivers and constraints are added. A control model is built with the control algorithm designed in Simulink; and a motor model is built according to a response characteristic curve of a motor. The final simulation optimization realizes the mechanical, motor and control integration design and optimization in the Simulink environment. The disadvantages of this method include: ADAMS has no parameterization function for the imported geometry model, and cannot achieve geometrical parameterization. In addition, in the Simulink environment, the ADAMS dynamics model can only be used as a subsystem to obtain the motion state of the mechanism, and can only optimize the control system parameters of a specific mechanical system. It is very difficult to achieve the simultaneous optimization of the mechanism and control. In addition, this method can only deal with a determined system. When the system has model nondeterminacy and disturbances, this method is powerless. More importantly, when the parameters of the mechanical system and the control system are optimized simultaneously, the design domains of the two are undetermined, and it is difficult to obtain a stable solution in regard to the optimization.

In the electromechanical system, the output of the system is a process requirement and is the goal of the design. Around this goal, the input (motion plan), mechanical and control system parameters could be comprehensively optimized and designed.

Since the control system is concerned with the problem on a signal tracking ability, the stability, accuracy, and rapidity that the system follows a certain reference signal are usually studied. When the system has model nondeterminacy and disturbances, the design of the control system becomes more difficult. Fortunately, the Auto-Disturbance Rejection Control (ADRC) algorithm developed from the ancient Chinese southward pointing cart has given us new ideas. The measured system state is compared with the prediction model by an extended state observer with the controlled object as the core to obtain the total disturbance of the system, and the disturbance is eliminated by an error elimination mechanism. This idea is very similar to the linearization iterative solution of a perturbation method or a nonlinear equation in mathematics. The selection of the linearized model (the mechanical system model and the prediction model) and the construction of an iterative format (the error elimination mechanism) influence the convergence and rapidity of the iteration.

A well-designed mechanical system could be similar to an ideal linearized model. According to the iterative convergence criterion in the nonlinear equation or the perturbation method in mathematics, the mechanical system and the prediction model are designed, the structure of an error eliminating link is designed, and the parameters of the mechanical system, the prediction model and the control system are comprehensively optimized, which can provide an entirely new approach for the integration design of the mechanical system and the control system.

### SUMMARY

In order to solve the problem that the existing art can only deal with a determined system and cannot deal with the situation when the system has model nondeterminacy and disturbances, the present invention proposes a mechanical and control integration design method in view of the auto-disturbance rejection control idea and the quick convergence design criterion of an iterative method in mathematics.

The technical solution adopted by the present invention is as follows.

A mechanical and control integration design method is proposed, comprising the following steps:

1) establishing a system dynamics model including nondeterminacy, regarding the estimation of an undetermined part as a disturbance;

2) performing parametric design to a determined part of a controlled object model to obtain a parameterized model;

3) truncating and simplifying the controlled object model according to the dynamic response characteristics of the object model and the controlled target requirements to obtain an approximate model as a prediction model;

4) measuring a system state, building a control performance judgment criterion, and calculating the difference with a calculation result of the prediction model to obtain a total disturbance;

5) designing a total disturbance eliminating link according to an iterative algorithm quickness criterion, and constructing and completing an auto-disturbance rejection controller;

and

6) simultaneously optimizing the parameters of a mechanical system and the auto-disturbance rejection controller with the goal of optimal control performance, and realizing the mechanical and control integration design.

Further, the undetermined system dynamics model is dividable into a determined part and a disturbance part.

Further, the determined part takes a median value, and the disturbance part is a model change and an external disturbance.

Further, the determined part of the controlled object model is parameterized to obtain a parameterized model.

Further, the prediction model is obtained by further approximately simplifying the parameterized model (for example, if the parameterized model has non-linearity, the model may be subjected to Taylor expansion to take a linear part).

Further, the motion state of the controlled object is fed back to construct the performance judgment criterion.

Further, the feedback of the motion state is subtracted from the calculation result of the prediction model to obtain the total disturbance of the system, and an extended state observer and a control law of eliminating errors are established by the auto-disturbance rejection control theory according to the order of the control system.

Further, the key parameters of the controlled object and the parameters of the extended state observer and the controller are simultaneously optimized with the goal of optimal the control performance to obtain the mechanical and control integration design.

Compared with the prior art, the beneficial effects are as follows: the present invention is based on the model prediction and disturbance elimination idea of the auto-disturbance rejection control, the controlled object is divided into a determined part and a disturbance part, the simplified and approximately parameterized model based on the determined part of the controlled object is constructed as an extended state observer and a parameterized disturbance elimination control link, and the parameters of the mechanical system and the control system are simultaneously optimized with a parameter optimizing method. The problem that the solution could not be performed due to an undetermined boundary when the parameters of the mechanical system and the control system are simultaneously optimized is overcome. Therefore, the existing method can only optimize the mechanical and control parameters in a single field in the case of the joint simulation of the mechanical system and the control system, and the design can be improved through a continuous iteration. With the method of the present invention, simultaneous optimization can be achieved.

### BRIEF DESCRIPTION OF THE DRAWINGS

FIG. 1 illustrates a transforming idea from a traditional electromechanical system design to an integration design.

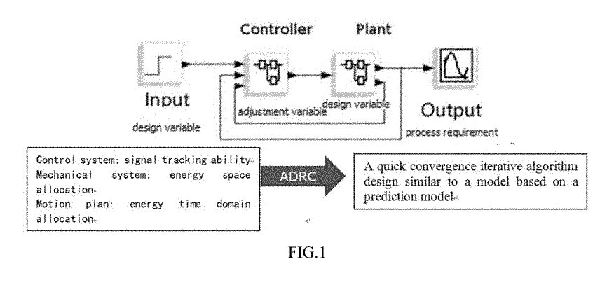

FIG. 2 illustrates the flow of a mechanical and control integration design of the present invention.

FIG. 3 illustrates an ideal motion model of a linear motion platform.

FIG. 4 illustrates an elastic deformation disturbance of a motion platform.

FIG. 5 illustrates design of a mechanical system with adjustable parameters.

### DETAILED DESCRIPTION

The drawings are only for illustrative description and could not be interpreted as limit to the present patent; for the sake of better description of the embodiment, some components of the drawings would be omitted, enlarged or reduced, and do not represent actual product dimensions; and those skilled in the art could understand that some of the well-known structures and their descriptions may be omitted in the drawings. The positional relationships described in the drawings are for illustrative description only and could not be interpreted as limit to the present patent.

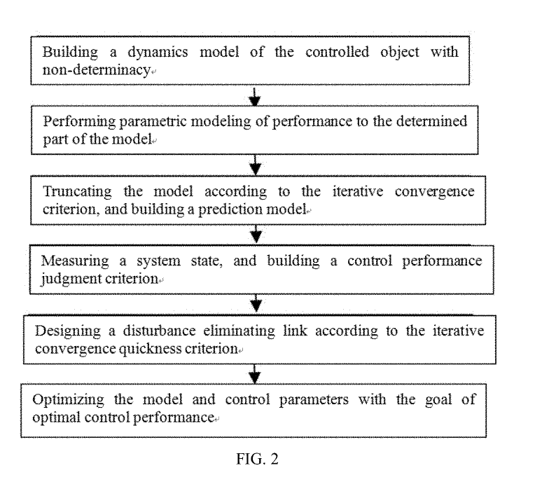

As shown in FIG. 2, using the idea of the present invention, the steps of the mechanical and control integration design method described in the present invention comprise:

1) establishing a system dynamics model with nondeterminacy, and indicating an undetermined part using estimation;

2) perform parametric design to a determined part of a controlled object model to obtain a parameterized model;

3) truncating and simplifying the controlled object model for the dynamic response of the object model and the control target requirements according to an iterative algorithm convergence criterion to establish a prediction model;

4) measuring a system state, building a control performance judgment criterion, and calculating the difference from the prediction model to obtain a total disturbance;

5) designing a total disturbance eliminating link according to an iterative algorithm quickness criterion, and constructing and completing an ADRC controller; and

6) simultaneously optimizing the parameters of a mechanical system and the ADRC control system with the goal of optimal the control performance, and realizing the mechanical and control integration design.

To illustrate the implementation of the method, the present invention provides an embodiment of a mobile platform design.

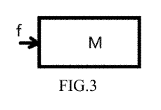

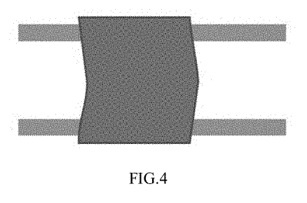

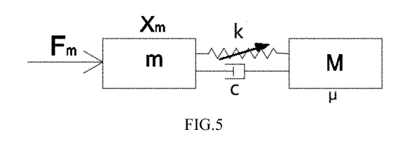

As shown in FIG. 3, the ideal motion platform is a rigid block M that produces a motion under a force f. Friction and elastic deformation are main disturbances of the platform motion. Herein, the disturbance that has the greatest influence on the positioning accuracy of the precision platform is the elastic vibration of the platform at a zero-crossing point of a speed. Because the rigidity of an existing platform structure is too large and the disturbance bandwidth is too large, a very high observer and controller bandwidth is required. In addition, because the platform could not be rigid, its elastic deformation is a simply supported beam stressed in the middle with a measuring sliding block as a fulcrum, and the deformation in the middle is larger than that at the two sides (FIG. 4). A consistent displacement output could not be achieved. Therefore, the platform needs to be set as a composite structure with adjustable rigidity, so that the platform remains relatively rigid. An equivalent dynamics model is established, as shown in FIG. 5. Herein, the mass of a core motion platform is m, the mass of the frame is M, and the rigidity and damping of a connection part are k and c, respectively.

A mechanical system dynamics model whose rigidity is a design parameter is established (or a dynamic characteristic adjustable mechanism is designed, and in this case, the adjustment parameters comprise the rigidity k and the mass m). With the ideal mechanical system dynamics model a=f/m as a prediction model (in the present example, b=1/m), an ADRC controller is established. The motion state (displacement, speed, and acceleration) of the system is measured, and the maximum displacement tracking error during the movement is calculated. With the goal of minimizing the maximum tracking error in a motion process, the parameters of the mechanical system and the control system are optimized.

Taking a high-speed precise motion platform as an example (FIG. 3), the mechanical and control integration method described in the present invention is used as follows.

1) A controlled object model including nondeterminacy is established:

M\ddot{x}=f(t)−f_{μ}(\dot{x})

Wherein M is the mass of the motion platform, the motion state x, \dot{x} and \ddot{x} indicate displacement, speed, and acceleration, respectively, f(t) is a control force function, and f_{μ}(\dot{x}) is a friction force function. Due to errors in the manufacturing and installation of guide rails, the friction forces are inconsistent at various places. In addition, there is a friction dead zone at the zero-crossing point of the speed. At this time, the friction force is undetermined and is non-derivable. The friction force could be treated as a disturbance. In addition, in the friction dead zone, the platform would have an elastic deformation, and is a simply supported beam stressed in the middle with a measuring sliding block as a fulcrum (FIG. 4). Its vibration response is influenced by the factors, such as rigidity, frequency and inertia of the platform. In order to obtain the optimal mechanical system parameters, the platform is redesigned. The newly designed platform consists of a motion platform (mass in), a flexible hinge (spring k and damping c) and a frame (mass M). The dynamics model is shown in FIG. 5.

2) A dynamics model is established for the determined part of the controlled object.

For the motion platform, its dynamic response equation is:

m\ddot{x}ₘ=fₘ−k(xₓ−x_{M})−c(\dot{x}ₘ−\dot{x}_{M}).

For the frame, its dynamic response equation is:

M\ddot{x}_{M}=k(xₘ−x_{M})+c(\dot{x}ₘ−\dot{x}_{M})−f_{μ}(\dot{x}_{M}).

Wherein, the rigidity of the flexible hinge is k, the damping thereof is c, the mass of the frame is M, the mass of the motion platform is m, and the subscripts m and M respectively indicate the stress and the motion state corresponding to the components that they belong to.

3) The model is equivalently simplified and the prediction model is built.

Since we are mainly concerned with the motion platform, the elastic vibration and the friction can be uniformly regarded as a disturbance. The simplified model after the disturbance is truncated is:

$${\ddot{x}}_{m} = \frac{{f}_{m}}{\tilde{m}} .$$

Considering the effect of rigidity, the equivalent mass m̅ is between the mass in and m+M, denoted by m̅=m+αM. When the spring rigidity is 0, α=0, and the equivalent mass is m. When the spring rigidity is infinite, α=1, and the equivalent mass is m+M.

Therefore, the prediction model is \ddot{x}ₘ=bu, wherein

$$b = \frac{1}{\tilde{m}}$$

and u=fₘ.

4) The motion state is measured, and the control performance indicator is determined.

The displacement xₘ of the motion platform is measured, and the control performance is measured by the tracking error (the absolute value of the difference between the actual displacement and the reference displacement r) |xₘ−r|.

5) The disturbance eliminating link is designed.

As the prediction model of the controlled object is a second-order system, it can be seen from the ADRC theory that the observation and control law of the second-order model is as follows:

z₁=∫[L₁(xₘ−z₁)+z₂]dt

z₂=∫[L₂(xₘ−z₁)+bu+z₃]dt

z₃=∫[L₃(xₘ−z₁)]dt

u=[−kₚ(xₘ−r)−k_{d}(z₂−r)−z₃]/b

z₁ is the estimation of the output displacement, z₂ is the estimation of the output speed, and z₂ is the estimation of the total disturbance. The design variables L₁,L₂,L₃ are the gains of the extended state observer, the design variables kₚ,k_{d} are the pd control gains, and u is the calculated control amount.

6) The mechanical control parameters are comprehensively optimized.

The goal is to minimize the tracking error:

$$min ( \vert y - r \vert )$$

$$find ( k , m , α , {L}_{1} , {L}_{2} , {L}_{3} , {k}_{p} , {k}_{d} ) .$$

In Matlab or ADAMS software, a system simulation optimization model is built, the optimization model is solved, and the optimal parameters are obtained.

In order to illustrate the advantages of the mechanical and control integration design, the present invention provides a comparison of three optimization schemes. The initial parameters of the system are shown in Table 1.

TABLE 1
Initial Parameters of the Platform

| | | Platform | Mass | Frame | | | | | |
|---|---|---|---|---|---|---|---|---|---|
| | Stiffness/ | Mass/ | Coefficient/mc | Mass/ | Differential | Proportional | Observer/ | Observer/ | Observer/ |
| Variable | k | mass | oef | M | Gain/kd | Gain/kp | L1 | L2 | L3 |
| Value | 100.00 | 1.0000 | 0.50000 | 3 | 100.00 | 10000. | 100.00 | 100.00 | 100.00 |

Scheme 1: With the goal of minimizing the maximum tracking error, the control parameters are optimized and a global optimizing method is adopted. After two iterations, the iteration converges. The maximum tracking error is reduced from 6 mm to 38 nm.

Scheme 2: Under the optimal control parameters, keeping up the goal of minimizing the maximum tracking error, the parameters of the mechanical system are optimized. It can be seen that when the optimization algorithm tries to change the quality coefficient mcoef, the tracking error becomes larger and the optimization solution ends. It is proved that, under the optimal control parameters, the performance could not be improved by changing the parameters of the mechanical system. This is the reason why the mechanical design would not be modified after the parameters of the control system are adjusted in the project.

Scheme 3: Under initial parameters, with the goal of minimizing the tracking error, the mechanical and control parameters are optimized simultaneously. After two iterations, the iteration converges. The maximum tracking error is reduced from 6 mm to 4.8 nm. Although the separate modification of the mechanical system alone has a slight change in the performance, and meanwhile, the parameters of the mechanical system and control system are modified simultaneously, the system would find a better global optimal point, thereby proving the advantages of the mechanical and control parameter integration design.

TABLE 2
Parameter Optimization of the Control System

| | Tracking | | | | | |
|---|---|---|---|---|---|---|
| Number | error | Parameters of the control system | | | | |
| of iterations Iter. | Error(mm) | kd | kp | L1 | L2 | L3 |
| 0 | 6.0415 | 100.00 | 10000. | 100.00 | 100.00 | 100.00 |
| 1 | 0.00016353 | 42.894 | 1.8089e+7 | 42.894 | 2.0054e+7 | 42.894 |
| 2 | 3.8347e−5 | 80.965 | 6.0364e+6 | 80.965 | 6.6846e+6 | 50081. |

TABLE 3
Parameter Optimization of the Mechanical System

| Number | | | | |
|---|---|---|---|---|
| of | Tracking | Parameters of the | | |
| iterations | error | mechanical system | | |
| Iter. | Error (mm) | k (N/mm) | Mass (kg) | mcoef |
| 0 | 3.8347e−005 | 100.00 | 1.0000 | 0.50000 |
| 1 | 3.8365e−005 | 100.00 | 1.0000 | 0.50050 |

TABLE 4
Comprehensive Optimization of the Parameters of the Mechanical System
and the Control System

| Number | | | | | | | | | |
|---|---|---|---|---|---|---|---|---|---|
| of | Tracking | Parameters of the mechanical | | | | | | | |
| iterations | error | system | | | Parameters of the control system | | | | |
| Iter. | Error(mm) | K(N/mm) | Mass(kg) | mcoef | kd | kp | L1 | L2 | L3 |
| 0 | 6.0415 | 100.00 | 1.0000 | 0.50000 | 100.00 | 10000. | 100.00 | 100.00 | 100.00 |
| 1 | 2.3062e−5 | 32.184 | 0.99999 | 0.49990 | 24.649 | 3.8177e7 | 24.649 | 4.2335e7 | 24.649 |
| 2 | 4.7568e−6 | 20.287 | 0.99999 | 0.49991 | 11.429 | 4.4873e7 | 11.429 | 4.9762e7 | 50011. |

The technical features of the embodiment described above may be combined arbitrarily. To make the description become concise, not all possible combinations of the technical features in the above embodiment are described. However, as long as there is no contradiction in the combinations of these technical features, the combinations should be considered as the scope described in this description.

Obviously, the above embodiment of the present invention is merely an example for clearly illustrating the present invention, rather than limiting the embodiments of the present invention. For those of ordinary skill in the art, other variations or changes may be made in different forms on the basis of the above description. All embodiments are unnecessarily and exhaustively illustrated herein. Any modification, equivalent replacement and improvement made within the spirit and principle of the present invention should be included in the protection scope of the claims of the present invention.

What is claimed is:

1. A mechanical and control integration design method, comprising the following steps:
1) building a system dynamics model with non-determinacy, and regarding the estimation of an undetermined part as a disturbance;
2) performing parametric design to a determined part of a controlled object model to obtain a parameterized model;
3) truncating and simplifying the controlled object model according to dynamic response characteristics of the object model and the controlled target requirements to obtain an approximate model as a prediction model;
4) measuring a system state, building a control performance judgment criterion, and calculating the difference with the calculation result of the prediction model to obtain the total disturbance;
5) designing a total disturbance eliminating link according to the order of the prediction model, and constructing and completing an auto-disturbance rejection controller; and
6) simultaneously optimizing the parameters of a mechanical system and the auto-disturbance rejection controller with the goal of optimal control performance, and realizing the mechanical and control integration design.

2. The mechanical and control integration design method according to claim 1, wherein the undetermined system dynamics model is dividable into a determined part and a disturbance part.

3. The mechanical and control integration design method according to claim 2, wherein for the undetermined system with upper and lower deviations, the determined part takes a median value, and the disturbance part is a model change part and an external disturbance.

4. The mechanical and control integration design method according to claim 2, wherein the parametric design is performed to the determined part of the controlled object model to obtain a parameterized model.

5. The mechanical and control integration design method according to claim 4, wherein the prediction model is obtained by further simplifying the model according to the complexity of the model.

6. The mechanical and control integration design method according to claim 5, wherein a motion state of the controlled object is fed back to construct a performance judgment criterion.

7. The mechanical and control integration design method according to claim 6, wherein the feedback of the motion state is subtracted from the calculation result of the prediction model to obtain the total disturbance of the system, and an extended state observer and a disturbance eliminating link are established according to the order of the prediction model.

8. The mechanical and control integration design method according to claim 7, wherein the key parameters of the controlled object and the parameters of the extended state observer and the controller are simultaneously optimized with the goal of optimal control performance to obtain the mechanical and control integration design.
